(19) United States
(12) Patent Application Publication
(10) Pub. No.: US 2010/0078553 A1
(43) Pub. Date: Apr. 1, 2010

(54) ATMOSPHERIC PRESSURE IONIZATION (API) INTERFACE STRUCTURES FOR A MASS SPECTROMETER

(75) Inventors: Thomas Corso, Groton, NY (US); John D. Henion, Trumansburg, NY (US)

Correspondence Address: FISH & RICHARDSON PC, P.O. BOX 1022, MINNEAPOLIS, MN, 55440-1022, US

(73) Assignee: ADVION BIOSCIENCES, INC., Ithaca, NY (US)

(21) Appl. No.: 12/565,320

(22) Filed: Sep. 23, 2009

Related U.S. Application Data
(60) Provisional application No. 61/101,240, filed on Sep. 30, 2008.

(51) Int. Cl. H01J 49/04

(52) U.S. Cl. 250/288; 250/292

(57) ABSTRACT

Atmospheric pressure ionization (API) interface structures such as API interface structures for mass spectrometers and related components, systems and methods are described herein.

### CROSS-REFERENCE TO RELATED APPLICATIONS

This application claims the benefit under 35 U.S.C. §119(e) of U.S. Application Ser. No. 61/101,240, filed on Sep. 30, 2008, which is incorporated by referenced herein.

### TECHNICAL FIELD

The invention relates to atmospheric pressure ionization (API) interface structures, such as API interface structures, for mass spectrometers.

### BACKGROUND

Mass spectrometry is an analytical process that identifies the chemical composition of a compound or sample based on the mass-to-charge ratio of charged particles. In general, in mass spectrometry, a sample undergoes ionization forming charged particles (ions). The ratio of mass-to-charge of the particles is determined by passing them through electric and/or magnetic fields in a mass spectrometer.

In some mass spectrometer systems, molecules can be analyzed in a quadrupole mass spectrometer using “electrospray” ionization to introduce the ions into the spectrometer. There are also other ways to produce gas-phase ions at atmospheric pressure (e.g., as described below). In electrospray ionization a spray needle may be positioned near to the entrance orifice of a quadrupole, magnetic, ion trap, Fourier transform mass spectrometer (FTMS), or time-of-flight (TOF) mass spectrometer, or close to the entrance of a capillary leading to a vacuum entrance orifice of the quadrupole or other type of mass spectrometer. A dilute solution, including the molecules of interest, is pumped through the electrospray needle and an electric potential between the needle orifice and a vacuum orifice (e.g., a reference electrode) leading to the mass analyzer forms a spray (“electrospray”) of the solution. The generation of the electrospray is carried out at atmospheric pressure and provides highly charged droplets of the solution. Since electrospray ionization occurs directly from solution at atmospheric pressure, the ions formed in this process can sometimes be strongly solvated. Prior to measurement, the solvent molecules associated with the ions are removed.

### SUMMARY

The invention relates to atmospheric pressure ionization (API) interface structures, such as API interface structures for mass spectrometers, and related components, systems and methods.

In certain aspects, a mass spectrometry system includes a vacuum region and a member defining a first opening, a second opening, and a non-linear passage extending from the first opening to the second opening A portion of the member in which the second opening is defined is positioned inside the vacuum region, and the member is positioned so that during operation of the mass spectrometry system ions enter the non-linear passage via the first opening and exit the non-linear passage via the second opening.

In some aspects, a mass spectrometry system includes a vacuum region and a member defining a first opening, a second opening, and a passage extending from the first opening to the second opening. A portion of the member in which the second opening is defined is positioned inside the vacuum region, and the member is positioned so that during operation of the mass spectrometry system ions enter the passage via the first opening and exit the passage via the second opening. A diameter of the passage decreases along a length of the passage in a direction from the first opening to the second opening.

In further aspects, a mass spectrometry system includes a member defining a passage having a first portion and a second portion. The first portion of the passage is configured to receive ions of a sample, and the second portion of the passage is configured to receive the ions of the sample from the first portion of the passage. The first portion of the passage has a first diameter, the second portion of the passage has a second diameter. The second inner diameter is smaller than the first diameter.

In some aspects, a mass spectrometry system can include an atmospheric pressure ionization (API) interface comprising a coiled capillary.

In some additional aspects, a mass spectrometry system can include an atmospheric pressure ionization (API) interface comprising a capillary having a decreasing inner diameter between an entrance to the capillary and an exit from the capillary.

In some further aspects, a mass spectrometry system can include an atmospheric pressure ionization (API) interface that includes a first capillary having a first inner diameter configured to receive electrospray from a sprayer (e.g., a device configured to generate an electrospray of a sample of interest such as a spray probe or a micro device). The API interface can also include a second capillary having a second inner diameter coupled to the first capillary and configured to receive the ions of the sample from the first capillary where the second inner diameter is less than the first inner diameter.

In some additional aspects, a spectrometry system can include an atmospheric pressure ionization (API) interface that includes a first portion formed of a first material having a first thermal conductivity and a second portion formed of a second material that is different from the first material. The second material can have a second thermal conductivity that is less than the first thermal conductivity.

Embodiments can include one or more of the following features.

In some embodiments, the non-linear passage has a length of at least 1.5 times (e.g., at least three times, at least five times) the length of a straight line extending from the first opening to the second opening.

In some embodiments, the non-linear passage has a diameter of from about 10 μm to about 500 μm (e.g., from about 50 μm to about 300 μm, from about 300 μm to about 500 μm).

In some embodiments, a diameter of the non-linear passage decreases along the length of the passage in a direction from the first opening to the second opening.

In some embodiments, the member is configured to define at least one step transition from a first diameter to a second diameter along the length of the non-linear passage, and the second diameter is smaller than the first diameter.

In some embodiments, the member includes a coiled capillary tube, and the non-linear passage extends along a coiled path from the first opening to the second opening.

In some embodiments, the coiled capillary tube has a coil diameter of from about 1 cm to about 10 cm (e.g., from about 4 cm to about 6 cm).

In some embodiments, the footprint length of the coiled capillary tube is from about 0.5 cm to about 25 cm (e.g., from about 4 cm to about 8 cm).

In some embodiments, the coiled capillary tube has a constant coil diameter.

In some embodiments, a coil diameter of the coiled capillary tube increases from a portion of the coiled capillary tube in which the first opening is defined to a portion of the coiled capillary tube in which the second opening is defined.

In some embodiments, a coil diameter of the coiled capillary tube decreases from a portion of the coiled capillary tube in which the first opening is defined to a portion of the coiled capillary tube in which the second opening is defined.

In some embodiments, the coiled capillary tube includes a capillary tube having a spooled arrangement including multiple nested coils.

In some embodiments, the system further includes a central tube surrounded by the nested coils.

In some embodiments, the central tube is heated.

In some embodiments, an electrical conduit is connected to the member to transmit an electric current through the member to heat the member.

In some embodiments, the member includes first and second adjacent layers, and the non-linear passage is formed between the first and second adjacent layers.

In some embodiments, the member is a chip.

In some embodiments, the vacuum region is configured to have a pressure of from about 10⁻⁶ torr to about 10⁻⁴ torr.

In some embodiments, a portion of the member in which the first opening is defined is positioned in a region configured to have a pressure greater than the vacuum region.

In some embodiments, the region in which the portion of the member defining the first opening is positioned has a pressure of from about 10⁻² torr to about 2 ATM.

In some embodiments, the region in which the portion of the member defining the first opening is positioned has a pressure between 10⁻² torr and 10⁻⁴ torr.

In some embodiments, an end region of the member is funnel-shaped.

In some embodiments, the system further includes a spray source configured to generate an electrospray including ions, and the spray source is configured so that at least some of the ions of the electrospray enter the non-linear passage via the first opening and exit the non-linear passage via the second opening when the spray source is operated in a manner to generate the electrospray.

In some embodiments, the system further includes a quadrupole mass analyzer positioned in the vacuum region, and the quadrupole mass analyzer is configured to receive ions exiting the second opening of the member.

In some embodiments, the diameter of the passage at an end region of the member in which the first opening is defined is from about 300 μm to about 800 μm (e.g., from about 400 μm to about 600 μm).

In some embodiments, the diameter of the passage at an end region of the member in which the second opening is defined is from about 50 μm to about 300 μm (e.g., from about 100 μm to about 200 μm).

In some embodiments, the member includes a capillary tube (e.g., a coiled capillary tube).

In some embodiments, the capillary tube includes a first tubular section and a second tubular section joined to the first tubular section, and the second tubular section has a substantially constant inner diameter.

In some embodiments, the inner diameter of the second tubular section is substantially equal to the inner diameter of an end region of the first tubular section to which the second tubular section is joined.

In some embodiments, an end region of the capillary tube is funnel-shaped.

In some embodiments, the first portion of the passage is configured to receive electrospray from a spray probe device, and the electrospray includes ions.

In some embodiments, the member includes a capillary tube having a first capillary tube segment and a second capillary tube segment. The first portion of the passage is defined by the first capillary tube segment, and the second portion of the passage is defined by the second capillary tube segment.

In some embodiments, the first capillary tube segment is directly connected to the second capillary tube segment.

In some embodiments, the first capillary tube segment is connected to the second capillary tube segment by a funnel-shaped interface.

In some embodiments, the first diameter is from about 300 μm to about 800 μm (e.g., from about 400 μm to about 600 μm).

In some embodiments, the second diameter is from about 50 μm to about 300 μm (e.g., from about 100 μm to about 200 μm).

In some embodiments, the first capillary tube segment includes a first material having a first thermal conductivity, and the second capillary tube segment includes a second material that is different from the first material. The second material has a second thermal conductivity that is less than the first thermal conductivity.

Without wishing to be bound by theory, it is believed that the API interface structures described herein can limit the conductance of the API interface, e.g., to limit the amount of gas transferred to the vacuum region. In some aspects, it is believed that configuring the API interface to limit the amount of gas transferred to the vacuum region can provide the advantage of reducing the pumping requirements for the system. Without wishing to be bound by theory, it is believed that the API interface structures described herein can reduce the likelihood of clogging of the API interface due to the diameter of the API interface near the sprayer that generates the electrospray.

An API interface having expanded or larger inside diameters can provide additional benefits. For example, such an interface can provide improved convectional mixing of the gas/ion mixture as it traverses the capillary API interface from the atmospheric pressure entrance region to the vacuum region inside the mass spectrometer system. It is contemplated that considerable desolvation is required inside the capillary interface to reduce the charged droplet diameter size and hence facilitate the ion evaporation process leading to the formation of gas-phase ions. It is further contemplated that changing the inside diameter and hence the conductance of the capillary during the passage of the gas/ion mixture through the capillary will facilitate this desolvation process.

### DESCRIPTION OF DRAWINGS

FIG. 1 is a schematic diagram of a mass spectrometry system.

FIG. 2 is a schematic diagram of a straight capillary.

FIGS. 3A-3C are schematic diagrams of material accumulation in a capillary.

FIG. 4A is a schematic diagram of a coiled capillary.

FIG. 4B is a cross sectional diagram of a coiled capillary.

FIG. 5A is a schematic diagram of a funnel-shaped coiled capillary.

FIG. 5B is a cross sectional diagram of a funnel-shaped coiled capillary.

FIG. 6A is a schematic diagram of a funnel-shaped coiled capillary.

FIG. 6B is a cross sectional diagram of a funnel-shaped coiled capillary.

FIG. 7 is a cross sectional diagram of a spooled coiled capillary.

FIG. 8 is a schematic diagram of a mass spectrometry system that includes a coiled capillary.

FIG. 9 is a schematic diagram of a funnel shaped capillary having a decreasing inner diameter.

FIGS. 10A and 10B are schematic diagrams of material accumulation in a capillary.

FIG. 11 is a schematic diagram of a capillary having different inner diameters in different regions of the capillary.

FIG. 12 is a schematic diagram of a capillary having different inner diameters in different regions of the capillary.

FIG. 13 is a schematic diagram of a capillary having different inner diameters in different regions of the capillary.

FIGS. 14A and 14B are schematic diagrams of a capillary having two sections with different inner diameters.

FIGS. 15A and 15B are schematic diagrams of a capillary having two sections with different inner diameters joined by a funnel shaped region.

FIGS. 16 and 17 are schematic diagrams of a capillary and a heating system.

FIG. 18 is a schematic diagram of a mass spectrometry system including a capillary having an inlet disposed in a sub-ambient region of the system.

FIGS. 19-23 are schematic diagrams of the orientation between the sprayer and the entrance to the capillary.

FIG. 24 is a schematic diagram of a serpentine-shaped capillary tube.

FIG. 25 is a perspective view of a chip that forms a serpentine-shaped passage.

FIG. 26 is an exploded view of the chip of FIG. 25.

Like reference symbols in the various drawings indicate like elements.

### DESCRIPTION

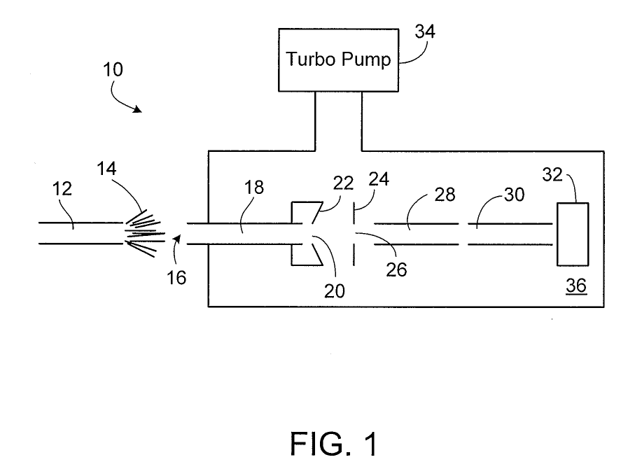

FIG. 1 is a schematic representation of a mass spectrometry system 10. Mass spectrometry system 10 is used to identify the chemical composition of a compound or sample based on the mass-to-charge ratio of charged particles. As described in more detail below, during use, a sprayer 12 generates an electrospray 14 that includes the ions of interest. Examples of a sprayer include a spray probe device, a chip-based spraying device, and a microfabricated sprayer device. The electrospray droplets enter into an atmospheric pressure interface (API), such as a capillary 18, that directs the ions from the electrospray into a vacuum portion 36 of the mass spectrometry system 10. As the droplets from the electrospray travel through the capillary 18, desolvation occurs such that ions emerge from an exit 20 of the capillary 18. The ions are directed through a skimmer 22 and the ions that emerge from the skimmer 22 are focused by a set of lenses 24 and into a multipole region 28. This multipole region is typically operated in the Rf-only mode and may be composed of a quadrupole, hexapole, octapole or similar ion optics device. In embodiments in which a hexapole device is used as the multipole region 28, the ions are further guided through a quadrupole analyzer 30 and into a detector 32. The detector 32 amplifies the weak ion current signal of the sample based on the mass-to-charge ratio of the ions.

More particularly, the mass spectrometry system 10 includes a sprayer 12 that generates a spray (e.g., an electrospray) of a solution that includes the molecules of interest. The sprayer 12 can be a small, charged capillary or a microfabricated chip-based emitter. A liquid that includes the molecules of interest dissolved in a solvent is directed through the sprayer 12 that has an applied voltage. As the liquid is expelled from the sprayer 12, the liquid forms the electrospray 14 (e.g., a mist of small droplets that can range from sub-micron size under nanoelectrospray conditions to about 1-10 μm across). The electrospray is typically generated at or near atmospheric pressure and provides highly charged droplets of the solution containing analytes. Ions analyzed by the mass spectrometry system 10 are formed by desolvation resulting in ion evaporation of the analytes in the charged droplets as the solvent is removed to produce gas-phase ions.

Prior to analysis of the ions by the mass analyzer (e.g., the quadrupole analyzer 30), the ions are transported from the atmospheric pressure region where the electrospray 14 is generated and into the vacuum region 36. The atmospheric pressure region where the electrospray is generated can be at one atmosphere pressure or below atmospheric pressure, for example, from about one atmosphere to 10⁻² torr. The vacuum region can be at a pressure of from about 10⁻⁴ torr to about 10⁻⁹ torr (e.g., from about 10⁻⁵ torr to about 10⁻⁶ torr). An atmospheric pressure interface, such as capillary 18, is located between the atmospheric pressure region and the vacuum region 36 such that an entrance 16 to capillary 18 is at atmospheric pressure and an exit 20 from the capillary 18 is at vacuum.

The capillary 18 can be configured to limit the conductance of the API interface, e.g., to limit the amount of gas transferred to the vacuum region 36. In some embodiments, for example, as described in more detail below, the API interface (e.g., capillary 18) can be a tube having multiple portions with different inner diameters or can be a coiled capillary tube. It is believed that configuring the API interface to limit the amount of gas transferred to the vacuum region can provide the advantage of reducing the pumping requirements relative to a larger inlet capillary (e.g., a capillary with a higher conductance). In some embodiments, such as the embodiment shown in FIG. 1, the pumping requirements can be reduced such that a single turbomolecular pump 34 can generate the desired vacuum in the mass spectrometry system 10. The pumping requirement can, for example, be reduced to an extent such that a single turbomolecular pump having a pumping capacity of 100 L/s or less (e.g., 50 L/s or less, 25 L/s or less, 15 L/s or less) can be used. In certain embodiments, the pumping requirement is reduced to an extent such that a single turbomolecular pump having a pumping capacity of about 11 L/s can be used.

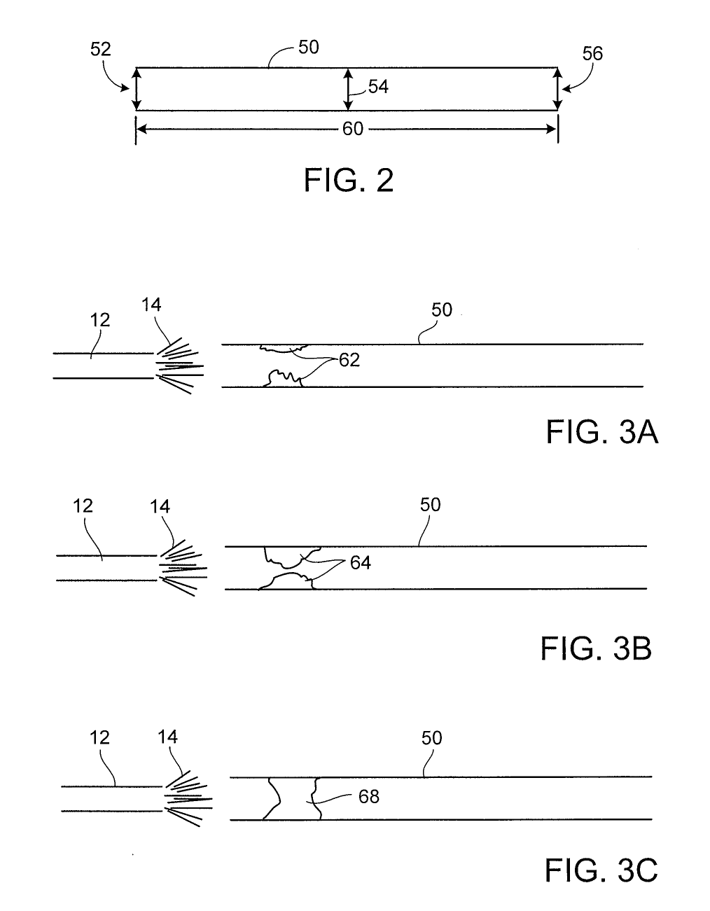

Referring to FIG. 2, in some embodiments, the API interface can be a long capillary tube 50 having a substantially constant inner diameter 54. For example, the inner diameter 54 at an entrance 52 to the capillary 50 (e.g., the portion at atmospheric pressure) can be substantially the same as the inner diameter 54 of the capillary 50 at the exit 56 from the capillary. In some embodiments, it can be beneficial to reduce the conductance of the capillary to limit the amount of gas transferred to the vacuum region of the mass spectrometry system 10. In order to reduce the conductance of the straight capillary 50, either the length of the capillary can be increased or the inner diameter of the capillary can be reduced. Size constraints of the mass spectrometry system 10 can place limits on the maximum length of the straight capillary 50. Due to the limits on the length 60 of the straight capillary 50, the inner diameter 54 of the capillary can be small. For example, the inner diameter 54 can be from about 5.0 μm to about 500 μm (e.g., from about 10 μm to about 300 μm). The length 60 of the capillary and the inner diameter of the capillary can be selected to provide a desired conductance for the capillary and the associated vacuum pumping system. For example, the conductance, Cᵥ, of the capillary can be determined according to: Cᵥ=68D4P/L, where P is the pressure at the high pressure end, D is the inside diameter of the capillary and L is the length of the capillary. One disadvantage of having a capillary 50 with a small inner diameter is the accumulation of material on the inner surface impeding the flow of ions through the capillary.

Referring to FIGS. 3A-3C, during use material from the electrospray 14 can accumulate on the inner surfaces of the capillary 50. Due to the small inner diameter of the capillary 50, the accumulation of material can severely limit the flow of the ions through the capillary or, in some circumstances, plug the capillary completely. As shown in FIG. 3A, as material 62 begins to accumulate on the inner surfaces of the capillary 50, the diameter of the capillary 50 is reduced at the location of the material 62. Since the inner diameter is reduced, fewer ions can flow through the capillary 50. As shown in FIG. 3B, as material 64 continues to accumulate on the surfaces of the capillary 50, the diameter of the capillary 50 at the point of the material 64 becomes even more limited and the flow of the ions through the capillary 50 is further restricted. As shown in FIG. 3C, if the material continues to accumulate on the inner surface, the material can form an occlusion 68 that completely clogs the capillary 50 and prevents the flow of ions through the capillary.

In some examples, the likelihood of material accumulating on the inner surfaces of the capillary occluding or clogging the capillary can be reduced by increasing the inner diameter of the capillary. While, an increased inner diameter can limit plugging that occurs from deposition of material on the inner wall, the increased cross section also increases the conductance of the capillary and allows an increased amount of gas to be transferred to the vacuum region. As described above, to offset the increase in the conductance due to the increased inner diameter, the length of the capillary can be increased. However, due to constraints on the foot print of the capillary (e.g., constraints on the space between the source 12 and the hexapole analyzer 28) the maximum length of the straight capillary may be constrained.

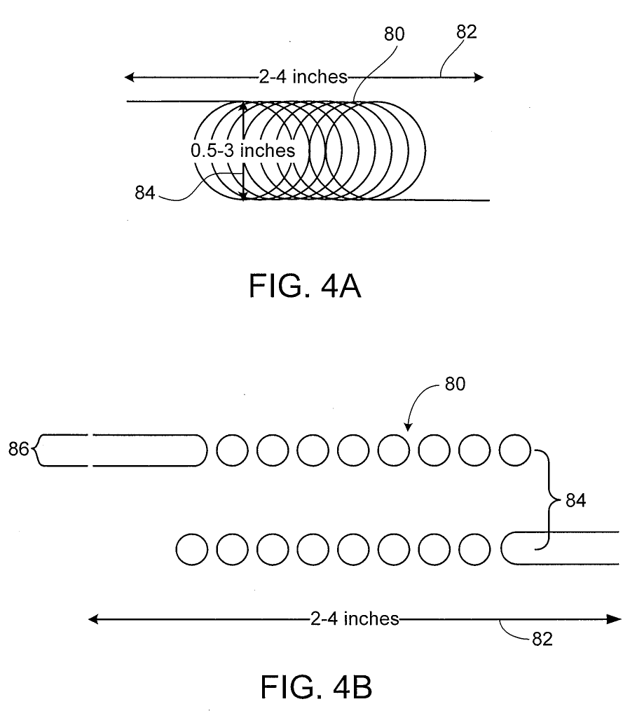

In some embodiments, as shown in FIGS. 4A and 4B, a capillary tube 80 that forms the API interface can be coiled to allow increased length of the capillary while taking up minimum space. FIG. 4A shows a schematic view of the coiled capillary 80 and FIG. 4B shows a cross sectional view of the coiled capillary in a plane through the length of the coiled capillary 80. The coiled shape of the capillary 80 allows for a larger inner diameter (ID) tube to be used due to the increased capillary length while maintaining a small foot print (e.g., indicated by footprint length 82). More particularly, the total capillary length of the coiled capillary 80 (e.g., the total distance the ions travel between the entrance of the capillary and the exit of the capillary or the length of the capillary if the coiling were unwound to form a straight capillary) is greater than the length 60 of the straight capillary 50 (FIG. 2) for the same footprint length (e.g., the distance between the entrance of the capillary and the exit of the capillary—in a straight capillary, the capillary length and the footprint length would be the same). For example, in the coiled capillary 80, a ratio of the capillary length to the footprint length 82 can be about 10:1 (e.g., about 8:1; about 20:3, about 10:3). In some embodiments, the capillary has a length of about 5 cm to about 20 cm. In certain embodiments, the footprint length is about 1 cm to about 5 cm.

In comparison to a straight capillary having the same footprint length (e.g., the same distance from entrance to exit) a coiled capillary 80 with the same conductance can have a larger inner diameter 86 due to the increased capillary length of the coiled capillary 80. The larger inner diameter 86 of the coiled capillary 80 can limit clogging or plugging of the capillary 80 because a greater amount of material would be required to be deposited in order to clog the capillary.

In some embodiments, the inner diameter of the coiled capillary can be from about 10 μm to about 1 mm (e.g., from about 100 μm to about 1000 μm, from about 300 μm to about 700 μm, about 500 μm).

Various coil diameters 84 can be used in the coiled capillary 80. The coil diameter 84 can be selected based on the footprint length 82 available for the coiled capillary 80 and the inner diameter 86 such that a desired capillary length of the coiled capillary 80 can be generated resulting in a desired conductance. For example, for a given inner diameter and desired conductance value, if the available footprint length 82 is increased, the coil diameter 84 could be decreased (to maintain the same capillary length of the coiled capillary) and if the available footprint length is decreased, the coil diameter 84 could be increased (to maintain the same capillary length of the coiled capillary). In some embodiments, the coil diameter 84 of the coiled capillary 80 can be from about 1 cm to about 10 cm (e.g., from about 2 cm to about 8 cm, from about 4 cm to about 6 cm, about 5 cm).

In some embodiments, the footprint length 82 of the coiled capillary 80 can be from about 2 cm to about 15 cm (e.g., from about 5 cm to about 8 cm, about 6 cm).

Without wishing to be bound by theory, it is believed that using a coiled capillary 80 as an API between atmosphere and vacuum can provide various advantages. In some examples, it is believed that the use of a coiled capillary can reduce clogging of the capillary due to the increased inner diameter 86 of the capillary. In some examples, it is believed that the use of a coiled capillary can reduce the vacuum pumping requirements to maintain an operational vacuum level. It is believed that the vacuum pumping requirements can be reduced because the coiling increases the capillary length of the capillary and provides a lower conductance for a capillary than the conductance of a straight capillary with the same inner diameter. In some examples, it is believed that using a coiled capillary can result in improved ion transport into the ion optics because the inner diameter of the capillary can be increased and allow a greater portion of the electrospray plume from the spray probe source to be collected by the capillary. In some examples, it is believed that the increased capillary length of a coiled capillary can result in increased desolvation efficiency for spray aerosol mixtures. In other examples, it is believed that the ion current conductance of a coiled capillary provides an efficient means of transporting ion current to the vacuum region.

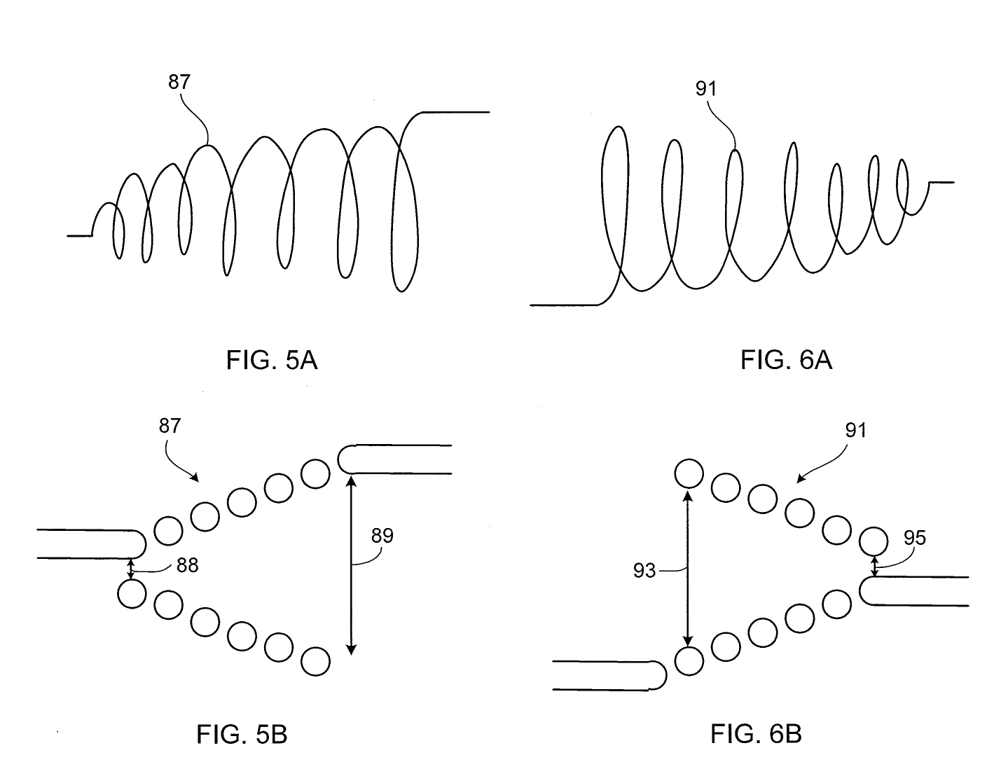

In some embodiments, the tightness of the coiling (e.g., the coil diameter) could vary over the length of the coiling. For example, as shown in FIGS. 5A and 5B, the coil diameter could vary to form a funnel shaped coil 87 with the coil diameter 89 at the exit being larger than the coil diameter 88 at the entrance. The coil diameter at the entrance 88 can be about 2 cm to about 5 cm (e.g., about 3 cm to about 4 cm), and the coil diameter 89 at the exit can be about 8 cm to about 15 cm (e.g., about 10 cm to about 12).

In another example, as shown in FIGS. 6A and 6B, the coil diameter could vary to form a funnel shaped coil 91 with the coil diameter 95 at the exit being smaller than the coil diameter 93 at the entrance. The coil diameter at the entrance 93 can be about 8 cm to about 15 cm (e.g., about 10 cm to about 12), and the coil diameter 95 at the exit can be about 2 cm to about 5 cm (e.g., about 3 cm to about 4 cm).

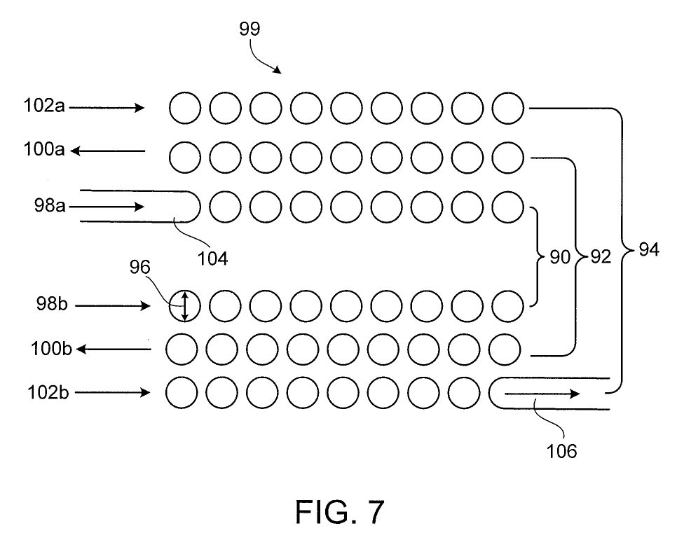

In some embodiments, the coiled capillary can have a spooled structure in which multiple coils are co-axially arranged. For example, FIG. 7 shows a cross sectional view of a spooled capillary 99 in a plane through the length of the spooled capillary 99. In the example shown in FIG. 7, the spooled capillary 99 has three nested coils. The inner-most coil has a coil diameter 90 that is less than the coil diameter 92 of a middle coil. The coil diameter 92 of the middle coil is less than the coil diameter 94 of the outermost coil. During use, the electrospray enters the spooled capillary in the innermost coil at an entrance 104 and proceeds in a direction away from the entrance 104 as indicated by arrows 98a and 98b. At the end of the first coil, the coil diameter is increased (to form the middle coil) and the direction of flow of the ions changes such that the ions flow through the middle coil in a direction toward the entrance 104 as indicated by arrows 100a and 100b. At the end of the middle coil, the coil diameter is again increased (to form the outer coil) and the direction of flow of the ions changes again such that the ions flow through the outer coil in a direction away from the entrance 104 and toward the exit 106 as indicated by arrows 102a and 102b. The ions exit the spooled capillary by exit 106. The length for the inner, middle and outer coils may be similar or different. The inside diameter of the capillary may be varied and associated with the capillary total length as appropriate to achieve maximum ion current transmission and analyte sensitivity while maintaining sufficient vacuum in the mass spectrometer system to perform mass analysis of the electrosprayed sample. In some embodiments, the coiled capillary can be formed around a hollow or a solid guide device such as a tube, bar, or rod. The outer surface of the coiled capillary can be in contact with the guide device to allow heat transfer between the guide device and the capillary. The capillary coil may be wrapped around either a solid core or rod which could allow transfer of heat to the capillary via direct heating of the solid core, or in another embodiment the capillary may be wrapped around a hollow core tube instead of a solid rod. It is believed that the use of a hollow core tube supporting the coiled capillary can provide the advantage of improving pumping of the vacuum system of the mass spectrometer by enabling better evacuation of this capillary chamber due to the nature of the hollow core tube supporting the coiled capillary.

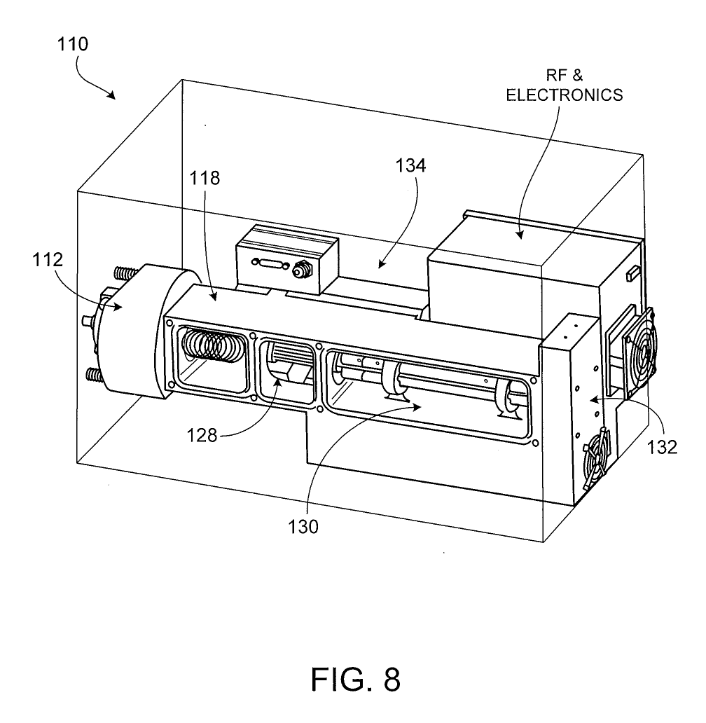

FIG. 8 is a diagram of a mass spectrometry system 110. The mass spectrometry system 110 includes a sprayer 112 that generates an electrospray that includes the ions of interest. The electrospray droplets enter into a coiled capillary 118 that serves as an atmospheric pressure ionization (API) interface and directs the ions from the electrospray region which is at or near atmospheric pressure (760 Torr) into a vacuum portion of the spectrometry system 110. As the droplets from the electrospray travel through the coiled capillary 118, which may or may not be heated, desolvation occurs such that ions emerge from the exit of the coiled capillary 118. The ions are directed into a multipole or hexapole region 128. From the hexapole region 128, the ions are further guided through a quadrupole analyzer 130 and into a detector 132. The detector 132 determines the identity of the sample based on the mass-to-charge ratio of charged particles.

In some embodiments, an API interface between the higher pressure or atmosphere region (e.g., the region where the electrospray is generated having a pressure of from about 10⁻² torr to about 2 ATM) and the vacuum region (e.g., the region inside the mass spectrometry tool having a pressure of from about 10⁻⁴ torr to about 10⁻⁹ torr) can include a capillary that has different cross-sectional areas (e.g., inner diameters) at different locations along the capillary. The different cross sectional areas can limit clogging of the capillary and can limit the amount of gas transferred to the vacuum region (e.g., to provide a low conductance). For example, as described in more detail in the examples that follow, a large inner diameter capillary can be provided on the atmospheric pressure side of the API to limit plugging from deposition of material on the inner wall. Further down stream (e.g., on the vacuum side), the inner diameter of the capillary can be smaller to provide a lower conductance for the API.

Without wishing to be bound by theory, it is believed that providing a capillary having a larger cross sectional area at the entrance (e.g., the atmospheric side) than at the exit (e.g., the vacuum side) can provide various advantages. It is believed that the differing cross-sectional areas allow higher flow rates to be used at the inlet to the capillary because the region with the smaller inner diameter reduces the conductance of the capillary. Having a larger diameter at the entrance to the capillary than at the exit from the capillary provides the additional advantage of capturing a larger percentage of spray plume of the electrospray in comparison to a capillary having a smaller, constant inner diameter. The larger entrance diameter also lessens the potential for clogging the capillary because a larger amount of accumulation is needed to impede the airflow through the capillary (e.g., due to the increased inner diameter, the same amount of accumulation will have a smaller affect on the airflow than in a capillary with a smaller inner diameter). In some embodiments, it is believed that having a larger entry inner diameter also improves the desolvation as the gas plume enters the capillary. It is believed that desolvation is improved because the electrospray process benefits from improved solvent evaporation conditions. The latter is facilitated by the addition of heat to the capillary and/or an increased interaction of the solvent/vapor/ion mixture with the walls of the capillary. This is believed to be facilitated by the electrospray droplets being funneled into the region with the smaller inner diameter. In some embodiments, the smaller inner diameter at the exit from the capillary minimizes pumping requirements relative to a larger capillary.

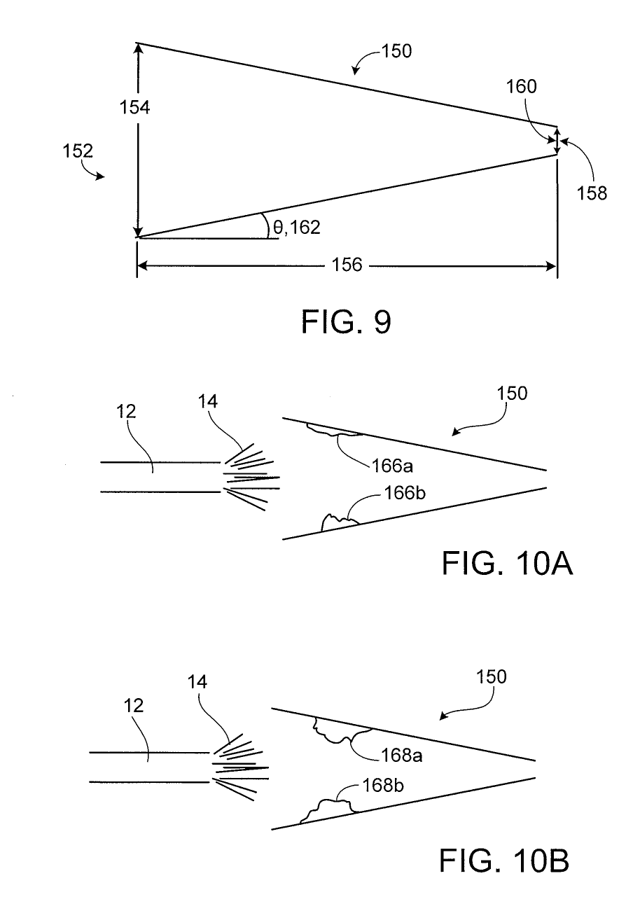

Referring to FIG. 9, a funnel-shaped capillary 150 having a decreasing inner diameter from an entrance to the capillary 152 to the exit from the capillary is shown. In the mass spectrometry system, the entrance to the capillary 150 is located near the sprayer 12 (e.g., in a region at or near atmospheric pressure) and collects the electrospray plume generated by the sprayer 12. The electrospray plume of solvent droplets/vapor and gas-phase ions travels through the capillary and exits into a vacuum region at the exit 158 of the capillary 150.

In some embodiments, the inner diameter 154 near the entrance to the capillary 150 (e.g., the end at near atmospheric pressure) can be from about 300 μm to about 800 μm (e.g., from about 400 μm to about 600 μm, about 500 μm). In some aspects, the inner diameter 154 near the entrance to the capillary can be selected to lessen the likelihood of clogging of the capillary due to accumulation of material on the inner surface of the capillary and/or to collect a desired portion of the electrospray 14.

In some embodiments, the inner diameter 160 near the exit from the capillary (e.g., the end at vacuum) can be from about 5 μm to about 200 μm (e.g., from about 10 μm to about 100 μm, from about 20 μm to about 75 μm, about 50 μm). In some aspects, the inner diameter 160 near the exit from the capillary can be selected to provide the desired conductance for the capillary 150. For example, the more narrow the inner diameter 160 near the exit from the capillary the lower the conductance of the capillary 150.

In some embodiments, a difference between the inner diameter 154 near the entrance to the capillary to the inner diameter 160 near the exit from the capillary can be from about 10 μm to about 1000 μm (e.g., from about 50 μm to about 500 μm, from about 50 μm to about 150 μm, from about 75 μm to about 125 μm). In some embodiments, a ratio of the inner diameter 154 near the entrance to the capillary to the inner diameter 160 near the exit from the capillary can be from about 1:10 to about 1:1000 (e.g., from about 1:50 to about 1:500, from about 1:50 to about 1:150, from about 1:75 to about 1:125, about 1:100). In some embodiments, the ratio of the inner diameter 154 near the entrance to the capillary to the inner diameter 160 near the exit from the capillary can be selected to achieve a practical working balance of maximum sampling of the electrospray plume at the entrance and an optimal working vacuum within the mass analyzer region of the mass spectrometry system. This will allow for increased sensitivity and utility of the described API MS system for a wide variety of analytical applications.

In some embodiments, the funnel shaped capillary 150 exhibits an angle 162 of from about 5 degrees to about 45 degrees (e.g., from about 20 degrees to about 30 degrees, about 25 degrees). The angle can be selected based on the maximum sampling of a portion of the electrospray plume at the entrance to the capillary interface with respect to the desired working pressure/vacuum in the mass spectrometry vacuum system in the region of the hexapole ion guide and the mass analyzer region. The selection of the angle can depend upon a proper balance of the entrance/exit inside diameters of the capillary API interface to the mass spectrometry system.

As shown in FIGS. 10A and 10B, it is believed that the funnel shape of capillary 150 allows material to be deposited on the inner surface of the capillary near the entrance of the capillary without clogging the capillary 150. As can be seen in FIGS. 10A and 10B (e.g., in comparison to FIGS. 3A-3C), due to the large diameter of the capillary 150 near the entrance, even as a substantial amount of material accumulates on the inner surface of the capillary 150, the capillary 150 does not become occluded.

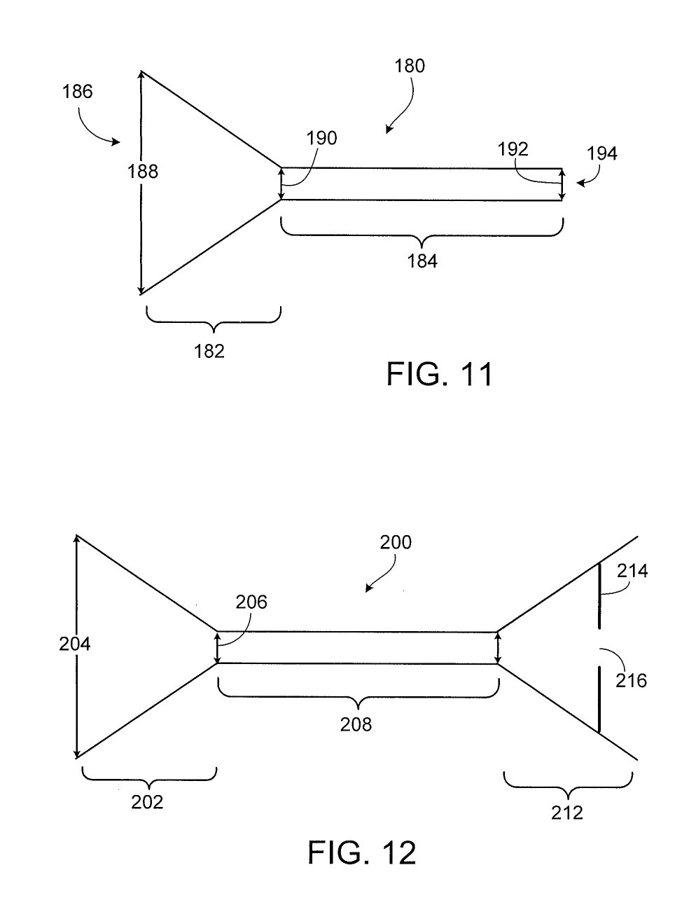

Referring to FIG. 11, another embodiment of a capillary 180 that has a larger inner diameter 188 at the entrance 186 to the capillary 150 than the inner diameter 192 at the exit 194 from the capillary 180 is shown. The capillary 180 includes a funnel region 182 connected to a straight region 184. The funnel region 182 can be short in comparison to the length of the straight region 184. In certain embodiments, the funnel region 182 has a length of about 0.5 cm to about 5.0 cm. It is believed that the funnel region 182 can provide one or more of the advantages described above in relation to funnel shaped capillary 150 such as allowing collection of a larger portion of the electrospray plume and reducing the likelihood of clogging of the capillary while the straight region 184 allows better control of the conductance of the capillary 180. It is believed that the straight region 184 provides increased control of the conductance because of the increased resistance to gas flow (lower conductance) of the smaller inside diameter of this portion of the capillary API interface.

In some embodiments, inner diameter near the entrance to the funnel shaped portion 182 of the capillary 180 (e.g., the end at near atmospheric pressure) can be from about 300 μm to about 800 μm (e.g., from about 400 μm to about 600 μm, about 500 μm).

In some embodiments, the funnel shaped portion 182 can be tapered such that an inner diameter 190 at the end of the funnel portion 182 is from about 5.0 μm to about 100 μm (e.g., from about 10 μm to about 50 μm, from about 25 μm to about 40 μm, about 20 μm). It is believed that the funnel shape of the funnel portion 182 of capillary 180 allows material to be deposited on the inner surface of the capillary near the entrance without clogging the capillary 180. The inner diameter 190 at the end of the funnel portion 182 can be maintained in the straight portion 184 of the capillary 180. As such, the inner diameter 192 at the exit 194 from the capillary 180 can be from about 5 μm to about 50 μm (e.g., from about 10 μm to about 40 μm, from about 15 μm to about 30 um, about 25 um).

Referring to FIG. 12, a capillary 200 having three regions 202, 208, and 212 is shown. The capillary 200 includes a funnel region 202 with a decreasing inner diameter connected to a straight region 206 (e.g., as described above in relation to FIG. 11). The straight region 206 is connected to a second funnel region 212 with an increasing inner diameter. The funnel regions 202 and 212 can be short in comparison to the length of the straight region 206. In certain embodiments, the funnel regions 202 and 212 have a length of about 0.5 cm to about 5.0 cm. It is believed that the funnel region 202 and straight region 208 can provide one or more of the advantages described above, such as allowing collection of a larger portion of the electrospray, reducing the likelihood of clogging of the capillary, and/or allowing better control of the conductance of the capillary. The second funnel shaped region 212 promotes free jet expansion of the ion stream that emerges from the straight portion 208. One advantage of the free jet expansion is the high linear velocity resulting from this process creates a dynamic ion current plume that may be captured by the ion skimmer 214. The presence of the diverging funnel 212 allows close positioning of the ion skimmer device 214 which optimizes sampling of the rapidly expanding ion beam resulting from the free-jet expansion in this region of the ion optics. A skimmer device 214 can be disposed in the second funnel shaped region 212 very close to sample the ions from the middle of the ion stream. The skimmer device can have an aperture 216 with a diameter similar to the diameter of the straight portion 208. The skimmer device may also be of a conical nature with the smaller orifice near the exit of 208 or it may be a flat plate with an orifice appropriately placed to sample the ion beam emerging from the free jet region of the system. However, since the skimmer 214 is located at a distance away from the exit of the straight region 208 where jet expansion of the ion stream has occurred, only a portion of the sample emerging from the straight portion 208 passes through the aperture 216 in the skimmer 214. The skimmer 214 can be configured to provide the maximum sampling and transmission of the ion beam emerging from the 212 region.

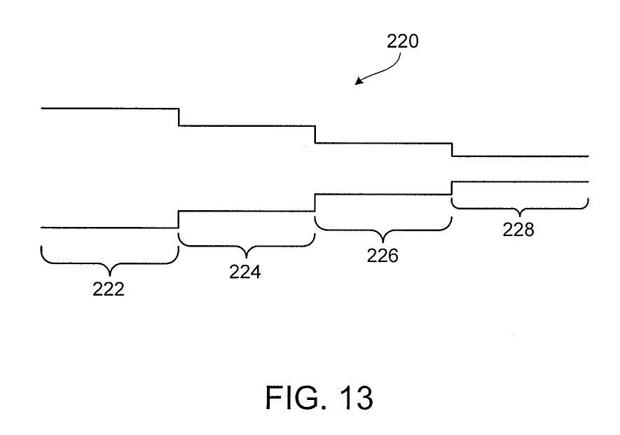

While in the examples shown in FIGS. 9, 11 and 12, the funnel shaped portion is shown as a continuous angled region, the funnel shaped portion could be formed of multiple discrete sections having decreasing inner diameters. For example, FIG. 13 shows a capillary 220 that includes multiple portions 222, 224, 226, and 228 with decreasing inner diameters. The number of sections can be from about 2 to about 10 (e.g., two, three, four, five, six, seven, eight, nine or ten). It is believed that providing a stepped structure such as the capillary 220 can provide similar advantages as a funnel shaped capillary.

In some embodiments, the capillary between atmospheric pressure (or near atmospheric pressure) and vacuum can be formed from two separate capillaries having differing inner and/or outer diameters. In some additional embodiments, the capillary could be formed of 3 or more capillaries joined together that have differing inner and/or outer diameters (e.g., 3 regions, 4 regions, 5 regions).

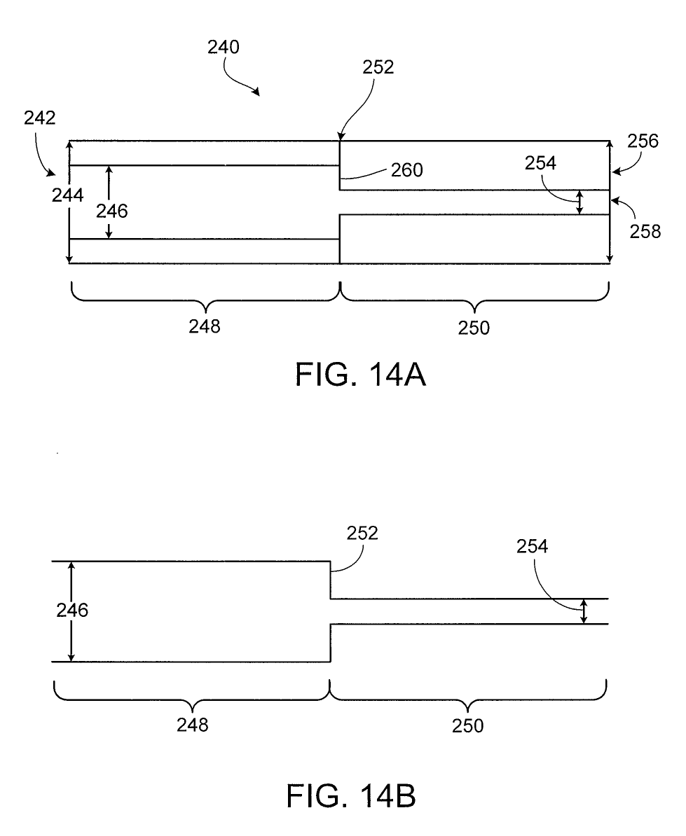

Referring to FIGS. 14A and 14B, a capillary 240 having two sections 248 and 250 of single diameter capillaries (e.g., straight capillaries) joined together at an interface 252 is shown. The two sections 248 and 250 have different inner diameters 246 and 254. The first section 248 (at the entrance from atmospheric pressure) can have a diameter of from about 300 μm to about 800 μm (e.g., from about 400 μm to about 600 μm, about 500 μm). The second section 250 (e.g., at the exit to a vacuum region) can have an inner diameter 254 of from about 1 μm to about 50 μm (e.g., from about 5 μm to about 30 μm, from about 1 μm to about 10 μm, about 5 μm). The two sections 248 and 250 can be joined by a fitting or a union connector or fused together by an appropriate process.

As shown in FIGS. 14A and 14B, the two sections 248 and 250 can be joined by a right angle interface 260. The sections 248 and 250 can, for example, be butt welded together, secured together using a shrink tube, etc. Alternatively or additionally, the sections 248 and 250 could have a telescopic configuration such that one of the tubes fits partially within the other tube. Without wishing to be bound by theory, it is believed that joining the two straight capillaries using a right angle could provide the benefit of increasing turbulence in the capillary 240.

In some embodiments, the two capillaries 248 and 250 that are joined together could be formed of the same material. In some additional embodiments, as described in more detail below, the capillaries 248 and 250 that are joined together could be formed of different materials, e.g., materials having different thermal conductivities or electrical insulating or conduction properties.

In some embodiments, the outer diameter of the two sections 248 and 250 can be substantially the same (e.g., as shown in FIG. 14A). It is believed that having the same outer diameters for the two sections 248 and 250 can offer the benefit of providing a thicker wall of the capillary on the section 250 with the narrower inner diameter. It is also believed that having the same outside diameter will facilitate construction of the capillary 240 system. The thicker wall of the capillary in section 250 can reduce the amount of heat transferred to the inside of the capillary in which the ions flow in comparison to a capillary with a thinner wall. Since desolvation occurs as the ions travel down the capillary 240 this allows the temperature in the capillary to be higher in a region of the capillary (e.g., the first portion 248) where more solvent exists. In other embodiments, the outer diameter of the two capillaries 248 and 250 can be different (e.g., as shown in FIG. 14B). It is believed that having different outer diameters can provide the advantage of coiling the capillary and facilitating heat transfer to this region of the 250 device in those instances where rapid heating at this region is desirable.

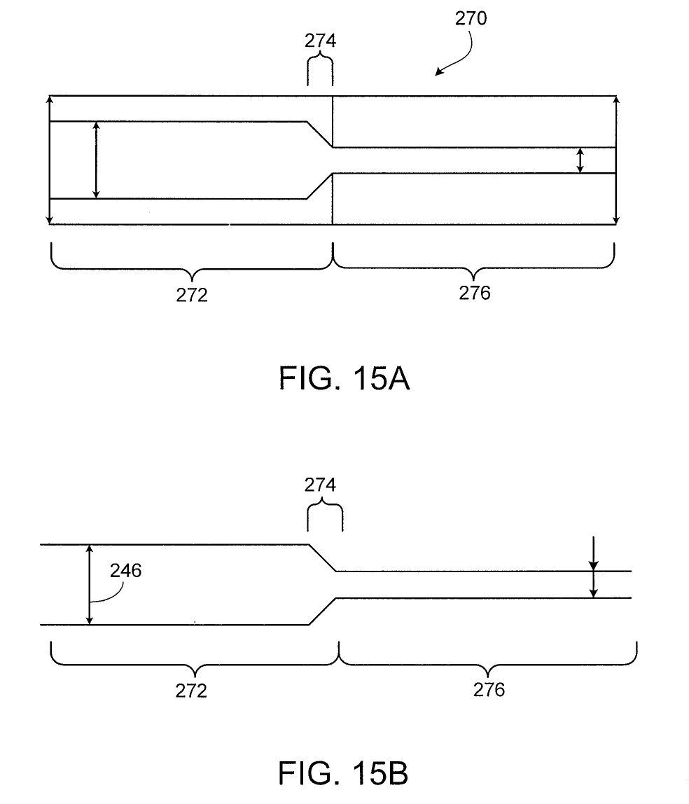

While in the embodiments shown in FIGS. 14A and 14B, the interface between two capillaries was formed at a 90 degree angle, in some embodiments, the two capillaries can be joined by a tapered interface. FIGS. 15A and 15B, show a capillary 270 having two capillary sections 272 and 276 joined together at a tapered interface region 274. Any of the various manufacturing techniques described above with respect to the sections 248 and 250 can be used to secure the sections 272 and 276 to one another. The tapered interface region 274 provides a funnel shaped region that guides the ions from the portion of capillary 272 with a larger inner diameter into the portion 276 with a smaller inner diameter. It is believed that joining the two regions using a tapered interface 274 can reduce the turbulence in the capillary 270 and promote laminar flow within the capillary 270. It is also believed this funnel feature of the capillary 270 will minimize dead volume and carryover from the droplet/vapor/ion current mixture traversing this capillary 270 device. The inner diameters of regions 272 and 276 can be similar to those of regions 248 and 250 of capillary 240 (FIGS. 14A and 14B).

It is believed that having two capillaries joined together with differing inside diameters (e.g., such as the examples shown in FIGS. 14A, 14B, 15A, and 15B) can provide various advantages. In comparison to a funnel shaped structure, joining two discrete capillaries can result in a simpler construction and manufacturing process. In comparison to a straight capillary, the larger inner diameter of the joined capillary structure (e.g., in the region near the entrance to the capillary) provides increased sensitivity of the mass spectrometry system due to collection and sampling of a higher percentage of spray plume while still providing a low conductance due to the small inner diameter of the second capillary. It is believed that having two capillaries joined together with differing inside diameters can also provide independent control of inlet and exit pressures and temperatures as well as independent control of inlet and exit voltages/potentials. This capability is beneficial due to the importance of controlled droplet evaporation and ion evaporation to produce the maximum ion current possible from the electrospray process.

The capillary structures described herein can be made of various materials. For example, the capillaries can be formed of metal, ceramic, fused-silica, quartz, polymer, composite. In general, the capillary is formed of a material that is chemically inert. The capillary can be either thermally insulative, semi-thermally conductive, or thermally conductive depending on the desired heating of the capillary and the ions within the capillary. In some examples, the capillary can be selectively conductive or insulative in different regions.

In some embodiments, a temperature control system can provide selective heating and/or cooling within the capillary. The capillary can be heated to a temperature of about 30 degrees Celsius to about 400 degrees Celsius. The heating can be resistive, conductive, radiant, or convective. In embodiments in which the capillary is formed of an electrically conductive material, resistive heating can be carried out by passing electrical current through the capillary. In such embodiments, the electrically conductive capillary acts as a resistor, and thus increases in temperature in response to the electrical current. In some embodiments, heat conduction is provided by wrapping a coiled capillary around a solid or hollow core, which itself is heated (e.g., electrically heated). In this way heat may be transferred from the heated core to the capillary. Convective heating can alternatively or additionally be used to heat the capillary. Such convective heating can, for example, be achieved by heating a housing of the mass spectrometry system. Heating the capillary can offset the natural cooling effects of solvent evaporation within the capillary and can facilitate spray solvent volatilization and ion transport through the capillary.

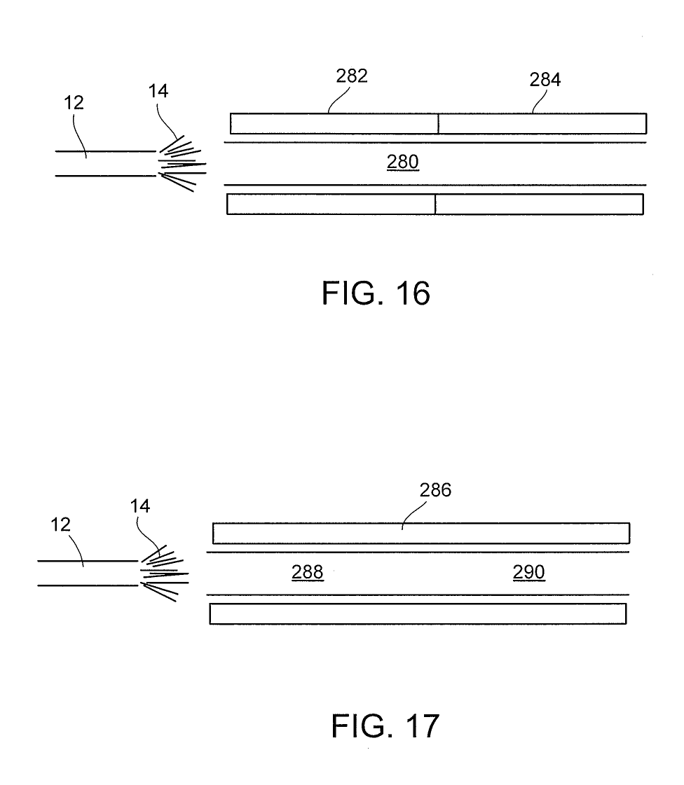

Referring to FIG. 16, a capillary 280 with selective temperature control is shown. The temperature control within the capillary is provided by two portions of a temperature control system 282 and 284. The first portion of the temperature control system 282 controls the temperature in a portion of the capillary 280 near the atmospheric pressure end where the electrospray 14 from the sprayer 12 enters the capillary 280. The second portion of the temperature control system 284 controls the temperature in a portion of the capillary 280 near the vacuum end where the desolvated ions exit from the capillary 280. The heating applies to the two portions 282 and 284 can be independently controlled, for example, to apply different amounts of heating/cooling to the front and rear portions of the capillary 280.

In some embodiments, a higher temperature can be applied to the region of the capillary near the higher pressure or atmospheric region using the first portion of the temperature control system 282 and a lower temperature can be applied to the region near the vacuum portion of the capillary using the second portion of the temperature control system 284. Without wishing to be bound by theory, it is believed that having a greater temperature inside the capillary near the atmospheric pressure region can be advantageous in desolvating the high concentration of larger drops produced by the electrospray process at or near atmospheric pressure. As the drops of electrospray plume travel through the capillary 280, the solvent evaporates leaving smaller droplets. Having a lower temperature inside the capillary near the vacuum region (where the droplets are smaller) can facilitate continued transport of the remaining smaller droplets as well as to minimize any potential thermal degradation of thermally fragile chemical analytes being transported by the capillary device 280

While in the embodiments described above in relation to FIG. 16 the selective heating of different portions of a capillary can be provided by multiple independently controlled heating/cooling systems, in some embodiments, a single heating system that applies the same amount of heat to the outside of the entire capillary can be used to generate different temperatures in the capillary.

FIG. 17 shows a capillary with two sections 288 and 290. The two sections 288 and 290 are formed such that when the same temperature is applied to an external surface of the sections 288 and 290 different temperatures result inside the capillary. For example, the two sections 288 and 290 can be formed of different materials where one material is more thermally conductive than the other material. In another example, the thickness of the walls of the two sections 288 and 290 can differ such that the heat transfer to the inside the capillary differs.

In the capillary shown in FIG. 17, the two regions 288 and 290 are formed of different materials, the same amount of heat can be applied to an external surface of both sections 288 and 290 of the capillary. The thermal conductivity of the material forming the capillary in the first region 288 can be greater than the thermal conductivity of the material forming the capillary in the second region 290. For example, a change in the thermal conductivity in the first region 288 relative to the thermal conductivity in the second region 290 can be from about 1 W/mK (in the first region) to about 500 W/mK (in the second region 290) (e.g., from about 1.1 W/mK, to about 429 W/mK, from about 12 W/mK, to about 318 W/mK, about 237 W/mK). Exemplary materials that can be used to form one or both of the regions 288 and 290 include glass which exhibits a thermal conductivity of about 1.1 W/mK, silver which exhibits a thermal conductivity of about 429 W/mK, stainless steel which exhibits a thermal conductivity of about 12 W/mK, gold which exhibits a thermal conductivity of about 318 W/mK, and/or aluminum which exhibits a thermal conductivity of about 237 W/mK.

Due to the higher thermal conductivity of region 288, when the same amount of heating is applied to sections 288 and 290, the amount of heat transferred to the inside of section 288 will be greater than the amount of heat transferred to the inside of section 290. As such, the temperature inside the capillary 292 near the atmospheric region (e.g., in region 288) will be greater than the temperature inside the capillary 292 near the vacuum region (e.g., in region 290). As noted above, without wishing to be bound by theory, it is believed that having a greater temperature inside the capillary near the atmospheric region can be advantageous in desolvating the drops of the electrospray.

In one example, the first region of the capillary 288 can be formed of metal (e.g., stainless steel, aluminum, or silver—each in turn having a higher thermal conductance), and the second region of the capillary 290 near the vacuum portion can be formed of fused silica, glass or ceramic materials.

Due to the differences in the thermal conductivity of a metal and fused silica, with the same application of heat to the outer surface of the metal and fused silica regions of the capillary, the metal region will result in a greater heat transfer into the inside of the capillary.

While in the examples described above, the two regions 288 and 290 were formed of different materials having different thermal conductivities, in some embodiments, the regions 288 and 290 could be formed of the same material and a thermally insulative layer could be applied to an outer surface of the capillary in portion 290.

In some embodiments the temperature in the first region 288 of the capillary can be from about 100° to about 350° (e.g., from about 150° to about 300°, from about 225° to about 275°, about 250°). In some embodiments the temperature in the second region 290 of the capillary can be from about 35° to about 200° (e.g., from about 50° to about 200°, about 100°). In some embodiments, the difference in the temperature between the first region 288 and the second region 290 can be from about 50° to about 150° (e.g., from about 75° to about 125°, about 100°).

The selective heating methods and systems described above can be combined with any of the capillary structures disclosed herein. For example, a coiled capillary could be formed of two different materials having different thermal conductivities and/or different regions of a capillary having different inner diameters could be formed of different materials.

While in certain embodiments the end regions of the capillary tubes are illustrated as having substantially constant inner diameters, it should be appreciated that the end regions of any of the capillary tubes described herein can have varying inner diameters. In certain embodiments, for example, the end regions of the capillary tube are funnel-shaped. In such embodiments, the ends of the capillary tube can have a greater inner diameter than the remaining length of the capillary tube. As an alternative to funnel-shaped end regions, the end regions of the capillary tube can include a segment of generally constant inner diameter that is slightly larger than the inner diameter of the remainder of the capillary tube. The end regions can alternatively be formed of a series of constant inner diameter segments that are secured to one another in a manner such that the inner diameter of the end regions gradually decrease toward the location where the end regions are connected to the remainder of the capillary tube. The end region segments are generally short in comparison to the length of the remainder of the capillary tube. The end region segments can, for example, have a length of about 0.5 cm to about 5.0 cm. The end region segments can be secured to the remainder of the capillary tube using any of the various attachment techniques described herein. In certain embodiments, the end region segments are integrally formed with the remainder of the capillary tube.

While in some of the examples described above, the ions emitted from the sprayer device were included in an electrospray, the capillary structures described herein can be combined with other ion generation methods. For example, as an alternative to or in addition to electrospray generation, other types of spraying techniques can be used to produce ions at or near atmospheric pressure that are sampled by the coiled capillary and/or capillaries having differing inner diameters described herein.

For example, in some embodiments, an Atmospheric Pressure Chemical Ionization (APCI) process could be used to generate the ions sampled by the capillary. In general, an APCI process is a method of producing gas-phase ions at atmospheric pressure via a corona discharge needle placed in the generally heated spray plume of a heated pneumatic nebulizer probe. The ions produced may be introduced into the vacuum system of an API mass spectrometer system. This technique can handle liquid flow rates, typically from an HPLC system, ranging from 0.1 mL/min to 2 mL/min and is amenable to the ionization and mass analysis of relatively involatile compounds ranging from molecular weights of 100 to 1200 daltons.

In some additional embodiments, a Desorption Electrospray Ionization (DESI) process could be used to generate the ions sampled by the capillary. A DESI process is an ‘open air ionization’ technique that produces gas-phase ions at atmospheric pressure by impinging a high velocity of nebulizing gas from a heated ‘ion spray-like’ probe which delivers charged, nebulized liquid droplets typically from aqueous-organic solvent combinations onto the surface of analytes of interest placed on a solid surface. This is believed to be a desorption technique and produces ions which may be sampled from an API ion source for subsequent mass spectrometric analysis. Since this is a surface ionization technique, HPLC sample introduction is not typically involved.

While the ion generation techniques described above involve using a sprayer, other non-spraying techniques can be used. In some additional embodiments, for example, a Direct Analysis in Real Time (DART) process could be used to generate the ions sampled by the capillary. A DART process produces gas-phase ions at atmospheric pressure. This technique uses heated, ionized helium or nitrogen gas ions to impinge under high velocity onto a chemical compound(s) placed on a solid surface. Similar in concept yet different in mechanism, DART provides ‘open air ionization’ without on-line HPLC separation of chemical mixtures.

As another example, an Atmospheric Pressure Solids Analysis Probe (ASAP) process could be used to generate the ions sampled by the capillary. An ASAP process is also an ‘open air ionization’ technique performed at atmospheric pressure. Similar to DART described above this ionization technique depends upon ionization of chemical compounds often placed on a glass surface in the absence of any solvent; e.g. the ionization is free from the effects of solvent. Ionization is believed to be caused by rapid thermal desorption of the analytes from the glass surface which are then ionized by a corona discharge similar to that described in the APCI technique.

The APCI process described above could also be modified to generate ions without the use of a sprayer. Such a process would be similar to the APCI process described above, but the corona discharge needle would not be positioned in a spray plume of a heated pneumatic nebulizer probe. Rather, the corona discharge needle would be placed in the open air near the inlet of the API (e.g., capillary tube).

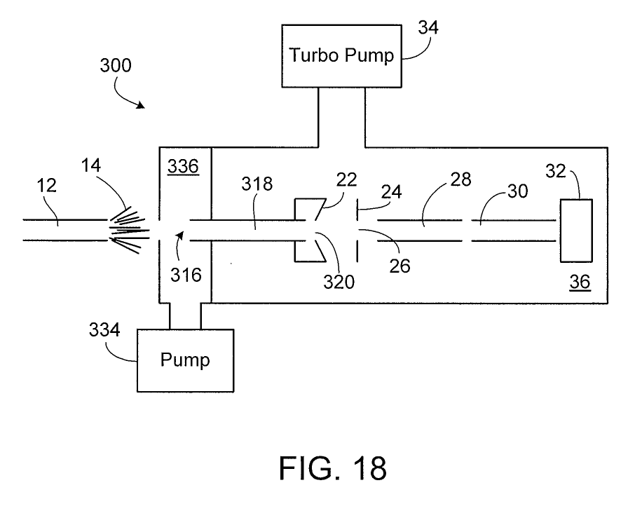

In certain embodiments, the inlet of the capillary tube is positioned in a region of the system that is below atmospheric pressure. As shown in FIG. 18, for example, a mass spectrometry system 300 includes a low vacuum region 336 and the high vacuum region 36. The pressure in the low vacuum region 336 is less than the ambient pressure and greater than the pressure within the high vacuum region 36. In certain embodiments, for example, the low vacuum region 336 has a pressure between 10⁻⁴ torr and 10⁻² torr (e.g., 10⁻³ torr), and the high vacuum region 36 has a pressure of about 10⁻⁶ torr to about 10⁻⁴ torr. The vacuum within the low vacuum region 336 is created by a vacuum pump 334 that is in fluid communication with the low vacuum region 336, and the vacuum within the high vacuum region 36 is created by the turbo pump 34, as discussed above. A capillary tube 318 having an inlet 316 and an outlet 320 is arranged such that the inlet 316 is positioned within the low vacuum region 336 and the outlet 320 is positioned within the high vacuum region 36. Because the inlet 316 of the capillary tube 318 is positioned in the low vacuum region 336, which is below ambient pressure, the capillary tube 318 can have a larger inner diameter and/or a shorter length than capillary tubes that have an inlet positioned at ambient pressure. The capillary tube 318 can otherwise be the same as any of the various other capillary tubes described herein. For example, the capillary tube 318 can be coiled and/or can have a varying inner diameter along its length. The mass spectrometry system 300 illustrated in FIG. 18 can be operated in a manner similar to the manner in which the various other mass spectrometry systems described herein are operated.

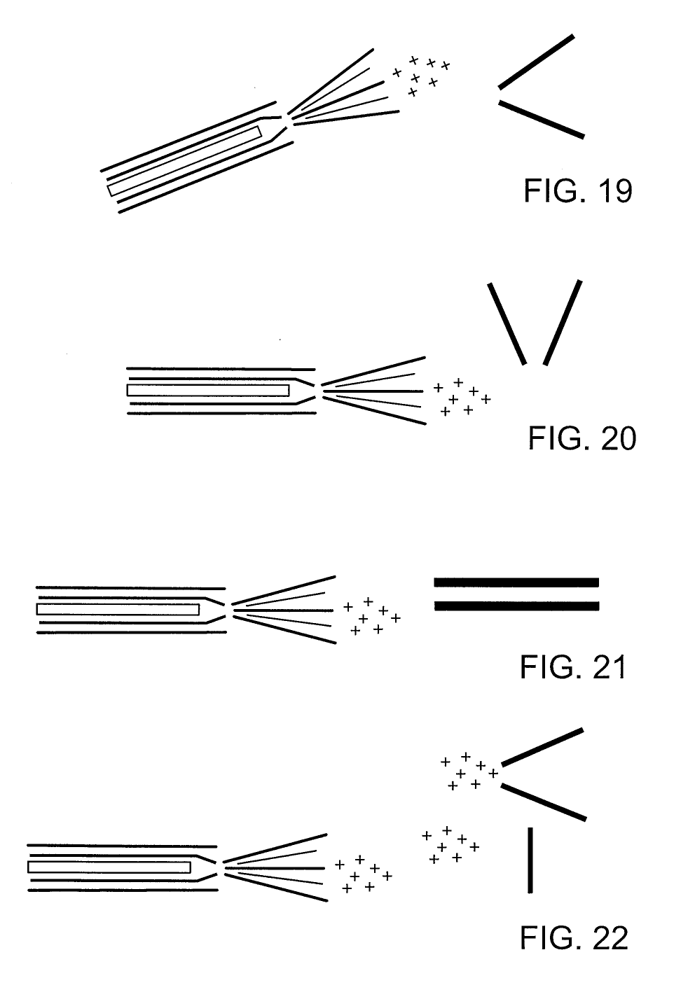

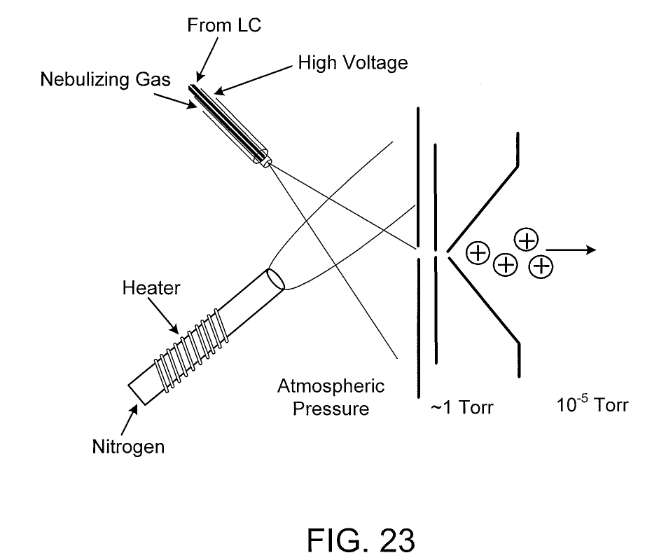

While in the embodiments shown above, the sprayer (e.g., electrospray, heated pneumatic nebulizer (for APCI), or other kinds of sprayers) that forms ions at or near atmospheric pressure is approximately aligned with the ion sampling orifice (e.g., the entrance to the coiled capillary or other capillary structures described herein), other orientations between the sprayer and the orifice can be used. In some embodiments, the sprayer can direct the spray plume on-axis and directly at the ion sampling orifice or entrance to the vacuum system of an API mass spectrometer (e.g., as shown above). In some additional embodiments, for example as shown in FIG. 19, the sprayer can be positioned at shallow angle (e.g., about 20-30 degrees) to the ion sampling orifice of the mass spectrometer system. In some additional embodiments, for example as shown in FIG. 20, the sprayer can be positioned at about 90 degrees to the ion sampling orifice for the purpose of reducing contamination of the system. In some additional embodiments, for example as shown in FIG. 21, the sprayer can be positioned on-axis to the ion sampling orifice and entrance to the vacuum system of their API mass spectrometer systems. In some additional embodiments, for example as shown in FIG. 22, the sprayer can be positioned such that the spray plume travels through two consecutive about 90 degree turns prior to entrance to the mass spectrometer vacuum system. It is believed that providing two 90 degree turns can to minimize contamination of the mass spectrometer system. In some embodiments, as shown in FIG. 23, an orthogonal combined sprayer/gas nebulizer arrangement can be used to generate the ions and direct the ions to the orifice of the capillary.

While in some of the embodiments described above, the mass spectrometry system included a quadrupole analyzer, other types of mass spectrometry systems could be used. For example, the capillary structures described herein could be used in magnetic mass spectrometer systems, ion traps, time-of-flight (TOF) mass spectrometer systems, and/or Fourier transform mass spectrometer systems.

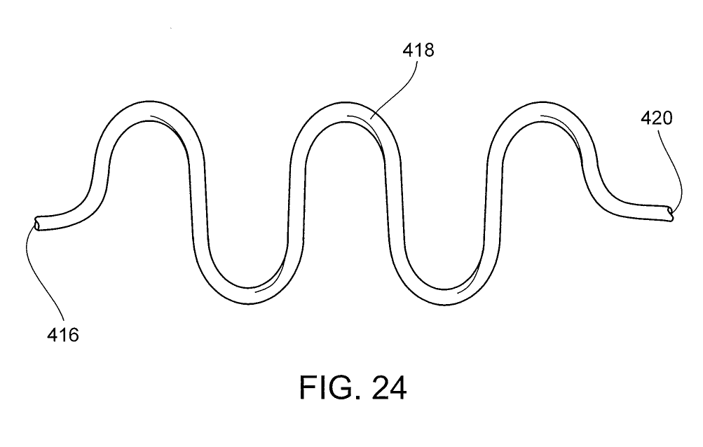

While certain capillary tubes have been described, any of various other capillary tube configurations that result in a lengthened passage between the inlet and outlet of the capillary tube can be used. For example, as shown in FIG. 24, a capillary tube 418 has a serpentine configuration. The capillary tube 418 has an inlet 416, an outlet 420, and a passage that extends between the inlet 416 and the outlet 420. As a result of the serpentine configuration of the capillary tube 418, during use of the capillary tube 418 with any of the mass spectrometry systems described herein, the travel path of the ions through the passage, from the inlet 416 to the outlet 420, is lengthened as compared to a linear passage that extends through a straight capillary tube having the same distance between the inlet and outlet (i.e., the same footprint length). While the capillary tube 418 has a different shape than the other capillary tubes described herein, the capillary tube 418 can otherwise have any of the various features described herein with respect to those other capillary tubes.

Other capillary tube configurations can similarly be used to lengthen the passage between the inlet and outlet of the capillary tube. Examples of such capillary tube configurations include other types of undulating patterns, circular or spiral patterns, zigzag patterns, etc.

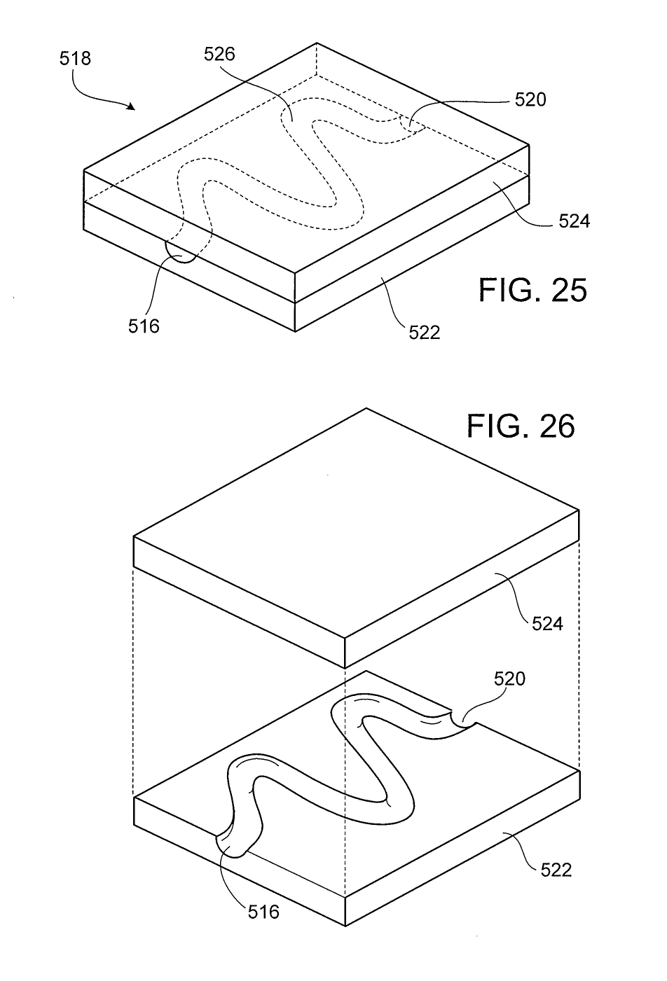

While certain embodiments above relate to capillary tubes that include non-linear passages extending therethrough, other types of members can alternatively or additionally be used to form non-linear passages that provide advantages similar to those of the passages extending through the capillary tubes described above. As shown in FIG. 25, for example, a chip 518 includes a first layer 522, a second layer 524, and a serpentine passage 526 (shown in dashed lines) that is formed between the first and second layers 522 and 524. The serpentine passage 526 extends from an inlet 516 to an outlet 520. The chip 518 can be used with any of the various different mass spectrometry systems described herein to provide a lengthened flow path for ions traveling through the passage 526.

Any of various different techniques can be used to make the chip. Referring to FIG. 26, in some cases, prior to attaching the second layer 524 to the first layer 522, a surface of the first layer 522 is etched to form a serpentine channel that runs from one edge of the first layer 522 to an opposite edge of the first layer 522. The second layer 524 is then attached to the surface of the first layer 522 in which the serpentine channel was etched. As a result, the serpentine passage 526 is formed between the first and second layers 522 and 524. As an alternative to etching, any of various other material removal techniques can be used to form the serpentine channel in the first layer.

Other flow passage shapes that can be used to lengthen the passage between the inlet and outlet of the chip include other undulating patterns, circular or spiral patterns, zigzag patterns, etc.

While embodiments above relate to capillary tubes and chips that define passages extending between an inlet and outlet, any of various other types of structures that define passages extending between an inlet and outlet can be used in place of the capillary tubes and chips.

Other embodiments are in the claims.

What is claimed is:

1. A mass spectrometry system, comprising:
a vacuum region; and
a member defining a first opening, a second opening, and a non-linear passage extending from the first opening to the second opening, wherein a portion of the member in which the second opening is defined is positioned inside the vacuum region, and the member is positioned so that during operation of the mass spectrometry system ions enter the non-linear passage via the first opening and exit the non-linear passage via the second opening.

2. The system of claim 1, wherein the non-linear passage has a length of at least 1.5 times the length of a straight line extending from the first opening to the second opening.

3. The system of claim 1, wherein the non-linear passage has a length of at least three times the length of a straight line extending from the first opening to the second opening.

4. The system of claim 1, wherein the non-linear passage has a length of at least five times the length of a straight line extending from the first opening to the second opening.

5. The system of claim 1, wherein the non-linear passage has a diameter of from about 10 μm to about 500 μm.

6. The system of claim 5, wherein the non-linear passage has a diameter of from about 50 μm to about 300 μm.

7. The system of claim 5, wherein the non-linear passage has a diameter of from about 300 μm to about 500 μm.

8. The system of claim 1, wherein a diameter of the non-linear passage decreases along the length of the passage in a direction from the first opening to the second opening.

9. The system of claim 8, wherein the member is configured to define at least one step transition from a first diameter to a second diameter along the length of the non-linear passage, the second diameter being smaller than the first diameter.

10. The system of claim 1, wherein the member comprises a coiled capillary tube, and the non-linear passage extends along a coiled path from the first opening to the second opening.

11. The system of claim 10, wherein the coiled capillary tube has a coil diameter of from about 1 cm to about 10 cm.

12. The system of claim 11, wherein the coiled capillary tube has a coil diameter of from about 4 cm to about 6 cm.

13. The system of claim 10, wherein the footprint length of the coiled capillary tube is from about 0.5 cm to about 25 cm.

14. The system of claim 13, wherein the footprint length of the coiled capillary tube is from about 4 cm to about 8 cm.

15. The system of claim 10, wherein the coiled capillary tube has a constant coil diameter.

16. The system of claim 10, wherein a coil diameter of the coiled capillary tube increases from a portion of the coiled capillary tube in which the first opening is defined to a portion of the coiled capillary tube in which the second opening is defined.

17. The system of claim 10, wherein a coil diameter of the coiled capillary tube decreases from a portion of the coiled capillary tube in which the first opening is defined to a portion of the coiled capillary tube in which the second opening is defined.

18. The system of claim 10, wherein the coiled capillary tube comprises a capillary tube having a spooled arrangement comprising multiple nested coils.

19. The system of claim 18, further comprising a central tube surrounded by the nested coils.

20. The system of claim 19, wherein the central tube is heated.

21. The system of claim 1, wherein an electrical conduit is connected to the member to transmit an electric current through the member to heat the member.

22. The system of claim 1, wherein the member includes first and second adjacent layers, and the non-linear passage is formed between the first and second adjacent layers.

23. The system of claim 22, wherein the member is a chip.

24. The system of claim 1, wherein the vacuum region is configured to have a pressure of from about 10⁻⁶ torr to about 10⁻⁴ torr.

25. The system of claim 1, wherein a portion of the member in which the first opening is defined is positioned in a region configured to have a pressure greater than the vacuum region.

26. The system of claim 25, wherein the region in which the portion of the member defining the first opening is positioned has a pressure of from about 10⁻² torr to about 2 ATM.

27. The system of claim 25, wherein the region in which the portion of the member defining the first opening is positioned has a pressure between 10⁻² torr and 10⁻⁴ torr.

28. The system of claim 1, wherein an end region of the member is funnel-shaped.

29. The system of claim 1, further comprising:
a spray source configured to generate an electrospray comprising ions, wherein the spray source is configured so that at least some of the ions of the electrospray enter the non-linear passage via the first opening and exit the non-linear passage via the second opening when the spray source is operated in a manner to generate the electrospray.

30. The system of claim 1, further comprising:
a quadrupole mass analyzer positioned in the vacuum region, the quadrupole mass analyzer being configured to receive ions exiting the second opening of the member.

31. A mass spectrometry system, comprising:
a vacuum region; and
a member defining a first opening, a second opening, and a passage extending from the first opening to the second opening, wherein a portion of the member in which the second opening is defined is positioned inside the vacuum region, and the member is positioned so that during operation of the mass spectrometry system ions enter the passage via the first opening and exit the passage via the second opening,
wherein a diameter of the passage decreases along a length of the passage in a direction from the first opening to the second opening.

32. A mass spectrometry system, comprising:
a member defining a passage having a first portion and a second portion, the first portion of the passage being configured to receive ions of a sample, and the second portion of the passage being configured to receive the ions of the sample from the first portion of the passage,
wherein the first portion of the passage has a first diameter, the second portion of the passage has a second diameter, and the second inner diameter is smaller than the first diameter.
